(19) United States
(12) Patent Application Publication
(10) Pub. No.: US 2011/0143866 A1
(43) Pub. Date: Jun. 16, 2011

(54) Core Tempo Golf Swing Training Tones

(75) Inventor: William Dean McConnell, Garland, TX (US)

(73) Assignee: William Dean McConnell, Garland, TX (US)

(21) Appl. No.: 12/637,708

(22) Filed: Dec. 14, 2009

(51) Int. Cl. A63B 69/36; G06F 17/00

(52) U.S. Cl. 473/409; 700/94

(57) ABSTRACT

A computer program product and method for generating an audio file and a method of training a golfer using the audio file on how to make a golf swing with a golf club and strike a golf ball through synchronization of golf club movement with an audio analog model of a preferred tempo-consistent golf swing comprising a pre-shot training sequence, a continuous backswing audio signal that models the backswing velocity of a clubhead, a continuous downswing to impact audio signal that models the downswing velocity of the clubhead, an impact audio signal that provides an indication to the golfer of when the peak clubhead speed should occur, and a followthrough audio signal that models the velocity of the clubhead from impact to the finish of the followthrough. In addition, a process for generating an audio file and a method of training a golfer using the audio file on how to make a putting stroke with a putter is included.

### CROSS REFERENCE TO RELATED APPLICATIONS

This application claims the benefit of provisional application serial number 61/1385304 filed on Dec. 17, 2008.

### STATEMENT REGARDING FEDERALLY SPONSORED RESEARCH OR DEVELOPMENT

Not Applicable

### DESCRIPTION OF ATTACHED APPENDIX

Computer Program Source Code Listing of Core Tempo software is in Appendix I CoreTempoSourceCodeListing.txt.

### BACKGROUND OF THE INVENTION

This invention relates generally to the field of golf swing training aids and more specifically to a method of training a golfer in how to make a consistent tempo golf swing with a golf club by synchronizing the golfer's movement of a golf club to continuous audio tones that represent a model of the dynamics of a clubhead associated with a preferred tempo-consistent golf swing whose timing is based on the Core Tempo timing of the golfer. Furthermore, this invention relates to a computer program product that generates a computer readable audio file that represents a preferred tempo-consistent golf swing. There have been many devices that have attempted to teach proper golf swing timing. The most common are metronome-based. U.S. Pat. No. 6,179,723 and U.S. Pat. No. 6,517,352 use metronome approaches. Each beat of a metronome occurs with periodic spacing in time from the previous beat. In using such a metronome approach, the golfer is supposed to start the takeaway coincident with the first beat, reach the top of the backswing with the second beat, and finish the downswing on the third beat. This method provides no beat for impact and teaches equal backswing and downswing times which is incorrect for the full swing. For a full golf swing, the backswing duration is proportionally longer than the downswing time. A second method provides a beat for the start of the backswing and a second beat for impact. This method suffers from the fact that there is no beat for the top of the backswing, thus, the golfer has no guide on how to proportion the backswing from the downswing. Therefore, periodic timing devices such as metronomes are generally not useful for full swing tempo training devices. Metronomes are also a popular means of training tempo for the putting stroke. One method suggests using the first beat to start the backswing, the second beat to mark the top of the backswing, and the third beat to mark the end of the followthrough. This method fails to provide a marker at impact. A second putting metronome method provides a beat to start the backswing and a second beat to mark impact, but this method fails to provide a signal at the top of the backswing. Still another method uses a metronome in a double beat mode where takeaway is started on the first beat, the second beat is ignored, the third beat marks the top of the backswing, and the fourth beat marks impact. This method suffers from the fact that it is very fast and can easily confuse the golfer. It has also has an inherent 2:1 backswing to downswing to impact ratio which differs from the 2.1:1 ratio established through analysis of hundreds of professional golfers' putting stroke. The metronome, being a periodic device, cannot provide this ratio and can only support a 2:1 ratio.

U.S. Pat. No. 7,217,197 to Park, provides the ability to provide indication of the durations of the backswing, top of swing pause, and downswing through monotone beeps or vibrations in one-tenth second resolution. A first short monotone sound cues the golfer to get ready. A second monotone sound activates for the duration of the backswing. At the top of the backswing, the unit is silent for a selected duration. A third monotone sounds for the duration of the full downswing. This approach overcomes the metronome's limitation but suffers from the lack of a signal to indicate to the golfer when impact should occur as well as a lack of intra-swing trend information. In addition, its minimum resolution is 100 milliseconds. In a golf swing, where even the slightest timing error can lead to a wayward drive, 100 milliseconds is too coarse of a resolution.

Another approach, U.S. 2007/0082325 A1 to Novosel, provides a device that plays short beeps or short musical beats as cues to indicate to a golfer when relevant parts of a golf swing should begin. Novosel teaches a cue to start the backswing, a cue to indicate the start of the downswing, and a cue to indicate impact, but there are no cues provided during the swing or for post-impact followthrough completion. The ratio of backswing time to downswing to impact time is pre-built into so-called long tones and is fixed at 3.0. The 3 to 1 ratio is based on video analysis of Tour Professionals by the inventor in which it was determined that the number of backswing frames equaled 3 times the number of downswing to impact frames. It was further surmised that there were four long tone Tour Tempo® groups which include 18/6™, 21/7®, 24/8®, and 27/9® that represent backswing frames in the numerator and downswing to impact frames in the denominator, both specified in NTSC video frames. For example, Tiger Woods Tour Tempo® is disclosed to be 24/8®, which is 24 frames, or 0.8 seconds, for the backswing and 8 frames, or 0.267 seconds, for the downswing to impact. There are several problems with this approach. Instead of providing signals that indicate the duration of constituent swing parts, U.S. 2007/0082325 A1 to Novosel provides cues that indicate when specific golf swing events should begin, but fails to provide continuous intra-swing trend information to the golfer between cues. Core Tempo overcomes this limitation by incorporating an audio sequence that represents an analog of the clubhead's speed, for the full swing, and a representation of the clubhead's angle, for putting into the overall sequence. Novosel teaches that when a golfer hears a cue or beat, it takes 0.2 seconds to react therefore the first and second cues are advanced by 0.2 seconds earlier to account for human reaction time. Human reaction time is not the same for all golfers and the effect of advancing the first and second cues by 0.2 seconds results in 18/6™, 21/7®, 24/8®, and 27/9® Tour Tempo® tones, actually being 18/12, 21/13, 24/14, and 27/15 respectively. Core Tempo overcomes this problem by providing an initial pre-shot training sequence that provides the golfer with a feel for the tempo of the swing before the swing begins. This fundamental tempo beat is based on takeaway to impact. Just as a musician listens to a beat and can continue the beat after the music stops or can watch a conductor's gestured tempo and begin playing the first note on beat, the golfer, can begin the backswing in synchronization with the backswing audio sequence after having heard the pre-shot sequence. Therefore, a human response delay need not be factored into the actual swing sequence since the pre-shot sequence alerts the golfer as to the swing's tempo beforehand. Novosel also teaches that all golfers including amateurs, women, senior, and juniors should swing as fast as PGA Tour Professionals. DXP Tech LLC has shown that every golfer has a unique personal downswing to impact timing called CoreTempo™. Not all golfers can swing with the speed and tempo of PGA Tour Professionals. Slower tempos than 9 frames or 0.30 seconds from downswing to impact are not provided in TourTempo® even though PGA Tour Professionals David Toms and Vaughn Taylor have downswing to impact tempos of 10 frames or 0.333 seconds. Novosel furthermore teaches that all full swings have a 3:1 ratio of backswing to downswing to impact. Research performed by DXP Tech LLC using 60 frame per second video analysis has concluded that PGA Tour Professional full swing ratios vary from as short as 2.2:1 for Brett Weterrich to as long as 4:1 for Ryan Moore. In addition, the same PGA Tour Professional will vary his golf swing ratio across a swing ratio range dependent on the club length. As an example, DXP Tech LLC has determined through high speed video analysis that Phil Mickelson has a swing ratio of 2.3:1 for a sand wedge, 2.5:1 for an 8 iron, 2.7:1 for a 3 Iron, and 2.8:1 for a driver. DXP Tech LLC discovered that, for a given golfer, his/her downswing to impact time is essentially constant for all clubs in the bag including the putter. That means that regardless of the club, the downswing to impact time is the same for a golfer. If a golfer takes 0.283 seconds from the downswing to impact for a driver, it should be the same for the 5 Iron, Pitching Wedge, and even the putter. The downswing to impact time is constant across all clubs while the backswing time varies with each club. Sixty seconds divided by two times the downswing to impact time is termed by DXP Tech LLC, the golfer's CoreTempo™ expressed in beats per minute. The ratio of backswing time to downswing to impact time is termed by DXP Tech LLC as the SwingRatio™. By specifying the golfer's CoreTempo™ in beats per minute with the golfer's SwingRatio™, the golfer's tempo can be precisely defined for each club.

### BRIEF SUMMARY OF THE INVENTION

The primary object of the invention is to provide a simple and accurate method of training a golfer in achieving consistent full swing tempo through the use of an audio model of a golf swing.

Another object of the invention is to generate a golf swing training audio file that the golfer can listen to on his/her IPOD (trademark of Apple Inc) or MP3 Player while practicing.

Another object of the invention is to provide a selection of overall swing tempo in beats per minute with a minimum resolution of 1 beat per minute and a range of 60 to 130 beats per minute.

Another object of the invention is to provide a selection of a variety of backswing to downswing to impact swing ratios from 2.0 to 4.0.

Yet another object of the invention is to provide an audio training sequence that guides a golfer in the execution of a putting stroke.

Still another object of the invention is to provide an easy to use golf swing audio training sequence that sounds like a golf swing and provides a continuous frequency modulated signal of the entire swing based on backswing, downswing, and followthrough velocity models of a golf swing.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a method of generating a computer-readable audio training file that models a preferred tempo-consistent golf swing used for training a golfer in how to make a preferred tempo-consistent golf swing with a golf club and strike a golf ball while listening and synchronizing the golf club movements to the computer-readable audio file, comprising the steps of inputting a core tempo in beats per minute whose half period matches a personal downswing to impact timing of said golfer, inputting a backswing to downswing to impact swing ratio from 2.0 to 4.0, opening a computer-readable audio file to hold generated digital audio samples incorporating core tempo and swing ratio in the computer-readable audio file filename, generating a pre-shot training sequence comprising a first beep and second bop momentary digital tone signal whose time spacing equals a sum of the core tempo half period and a product of the core tempo half period multiplied by the swing ratio, generating a digital silence pre-shot pause period whose duration equals the sum of the core tempo half period and the product of the core tempo timing multiplied by the swing ratio, generating a continuous backswing digital audio signal whose frequency is proportional to a backswing velocity model of the clubhead of the golf club for a duration equal to the product of the core tempo half period multiplied by the swing ratio, generating a continuous downswing digital audio signal whose frequency is proportional to a downswing velocity model of the golf club for a duration equal to the core tempo half period, generating a short impact chirp digital tone signal which indicates a peak speed of the clubhead of the golf club, generating a continuous post impact followthrough digital audio signal whose frequency is proportional to a followthrough velocity model of the clubhead of the golf club after collision with the golf ball for a duration equal to the product of the core tempo half period multiplied by the swing ratio, generating a post followthrough digital silence period for a duration equal to the sum of the core tempo half period and the product of the core tempo half period multiplied by the swing ratio, and, closing the computer-readable audio file.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a view of a golfer at address position. FIG. 2 is a view of a golfer at the top of the backswing. FIG. 3 is a view of a golfer at impact. FIG. 4 is a view of a golfer at the finish position. FIGS. 5a through 5i show flow charts containing Program Design Language of the computer program process of generating the Core Tempo tones audio file for the full swing. FIG. 6 is a view of a golfer at the putting address position. FIG. 7 is a view of the golfer at the top of the backswing during a putting stroke. FIG. 8 is a view of a golfer at impact during a putting stroke. FIGS. 9a through 9g show flow charts containing Program Design Language of the computer program process of generating the Core Tempo tones audio file for the putting stroke.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

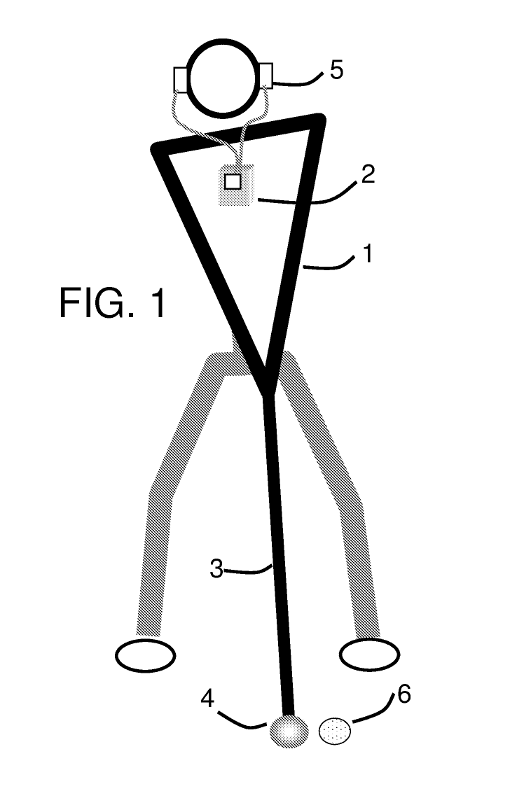

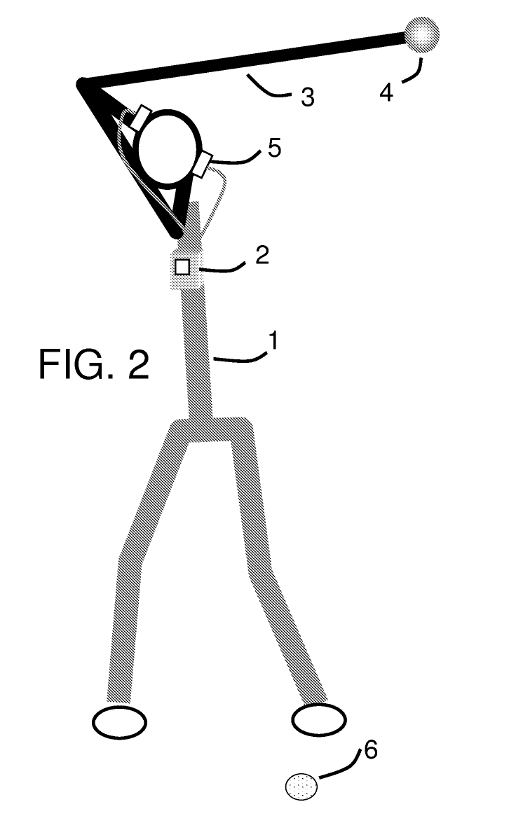

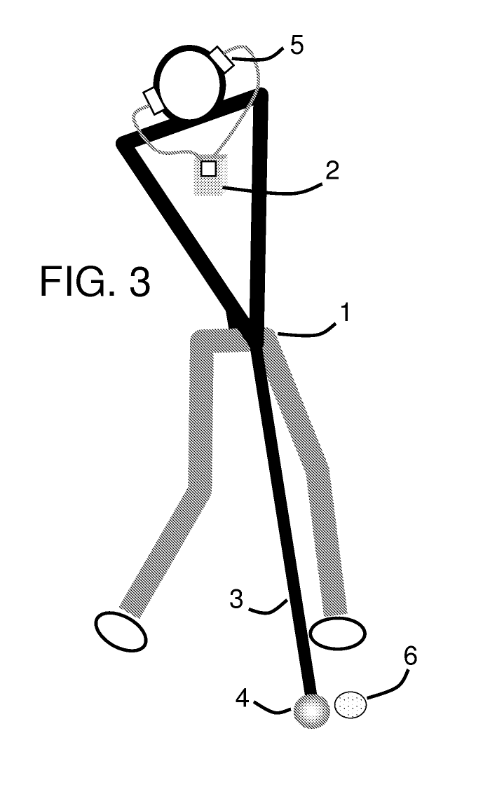

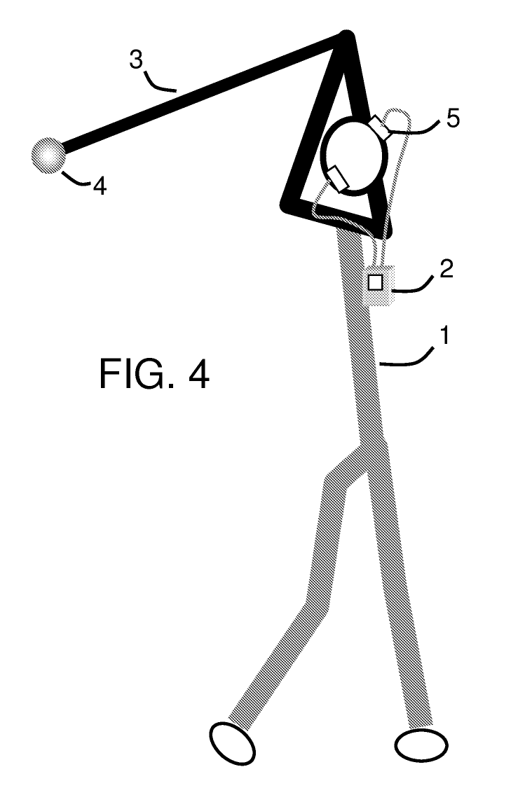

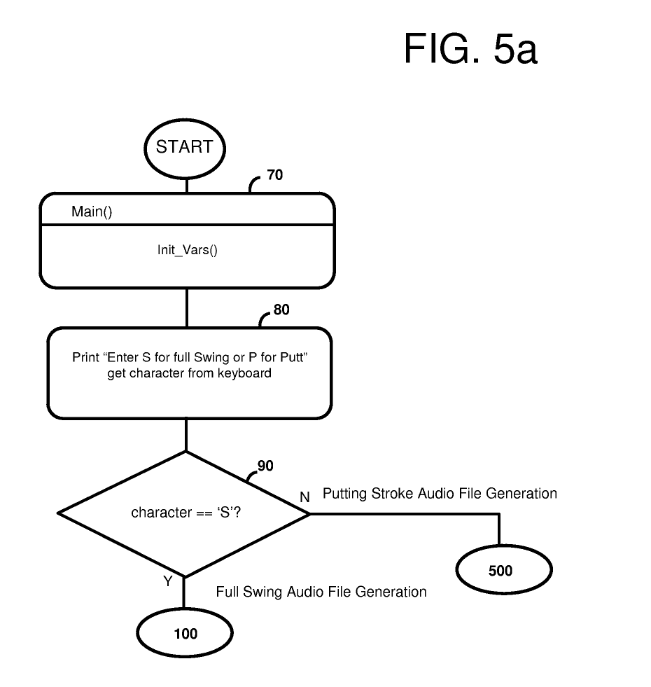

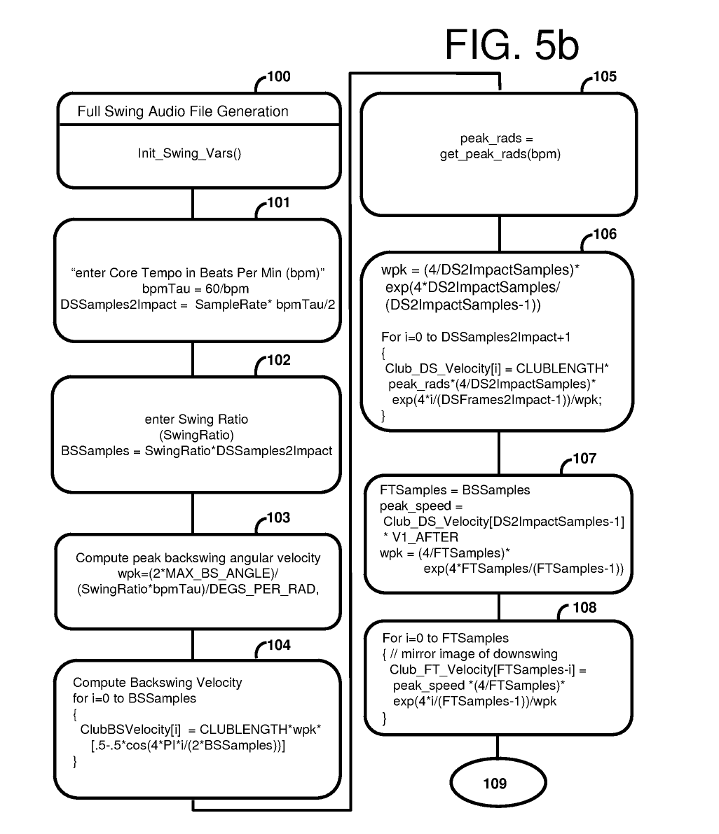

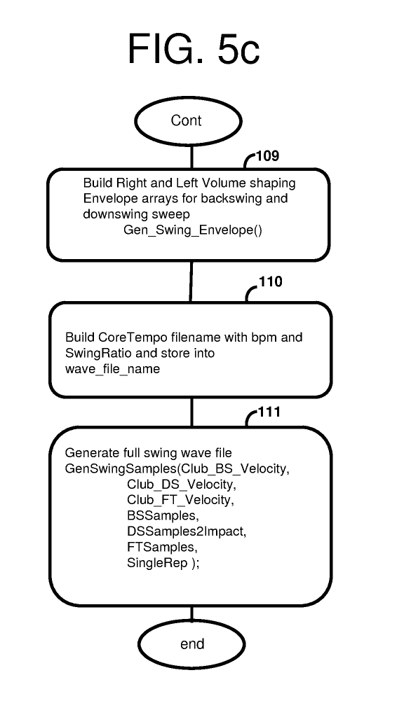

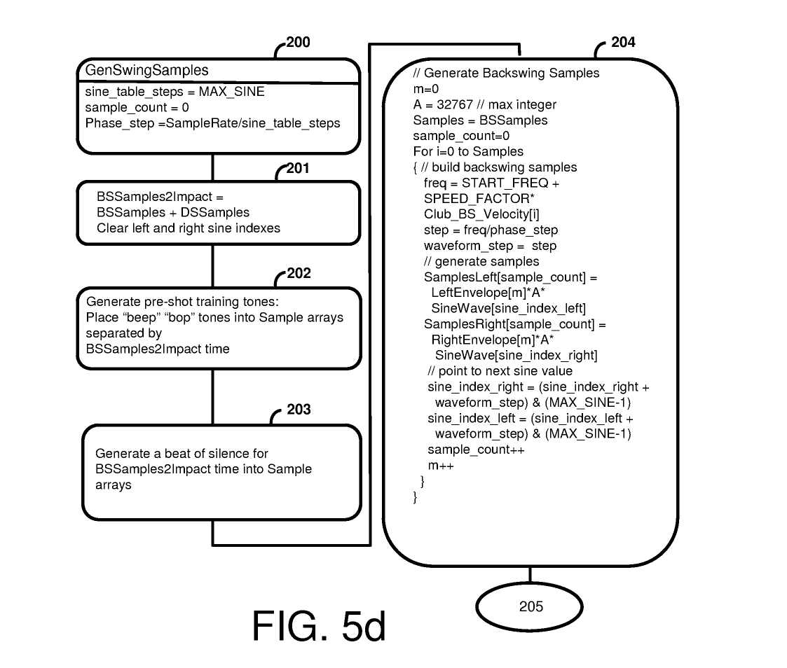

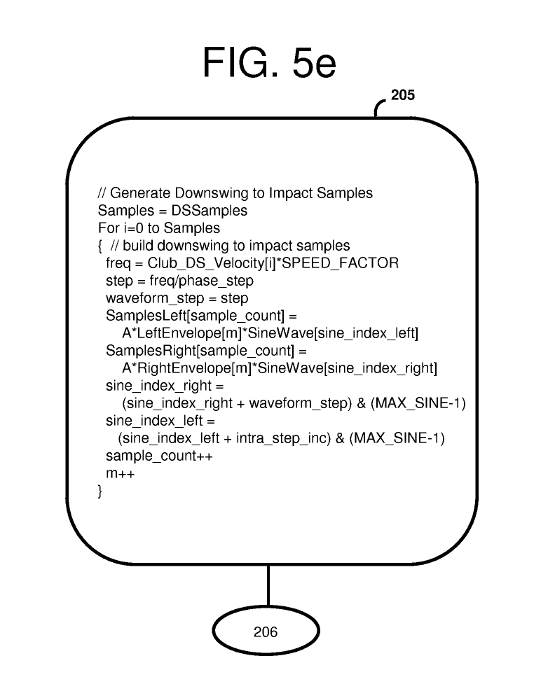

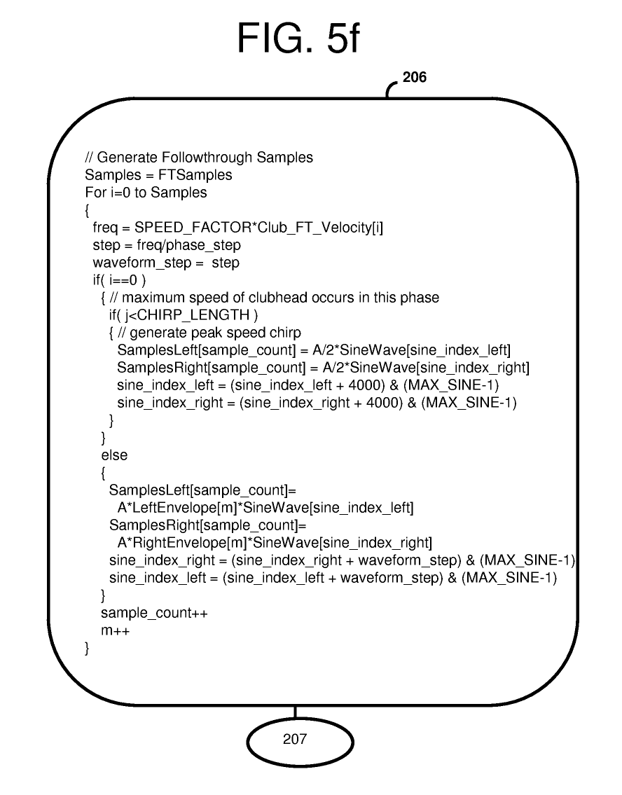

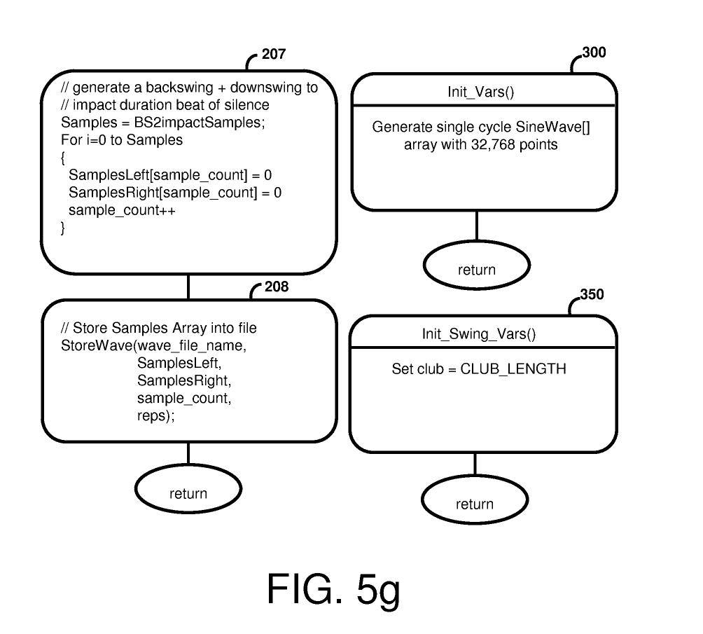

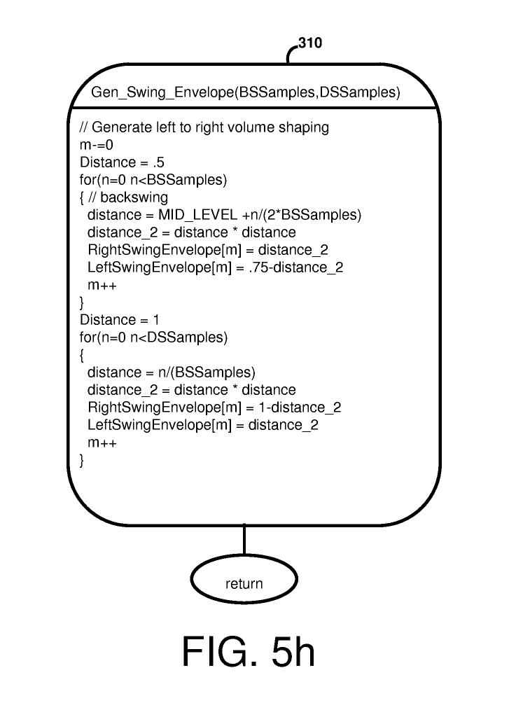

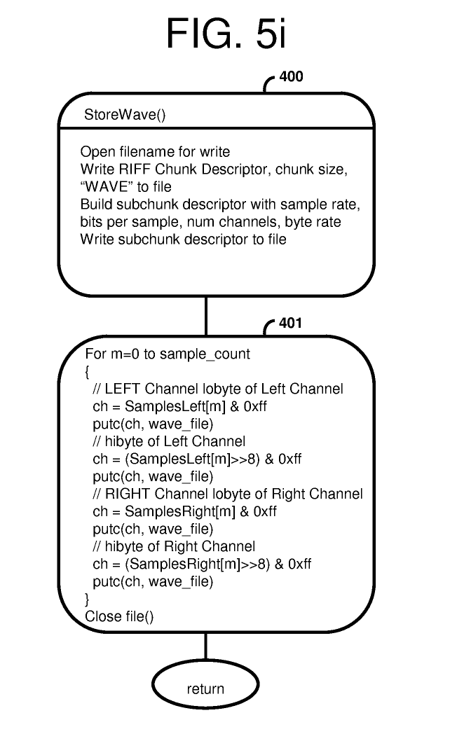

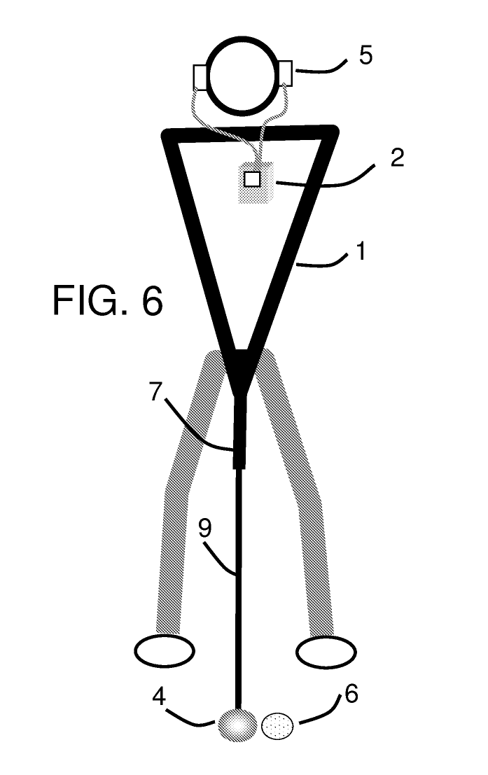

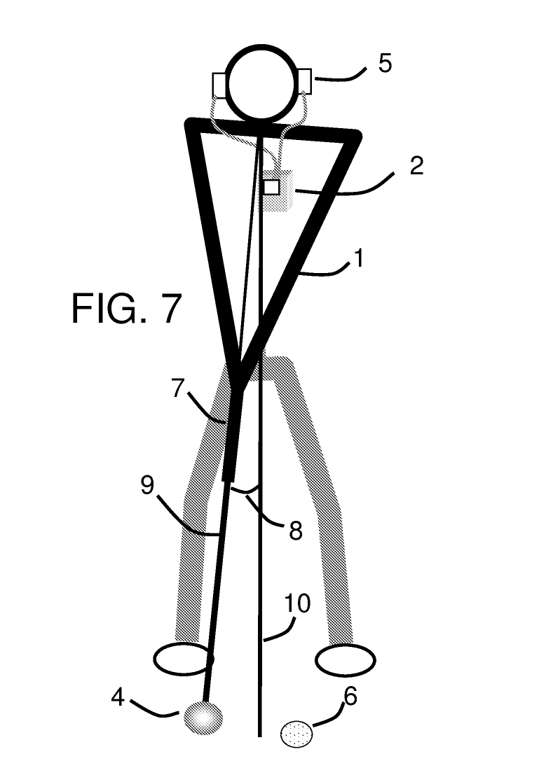

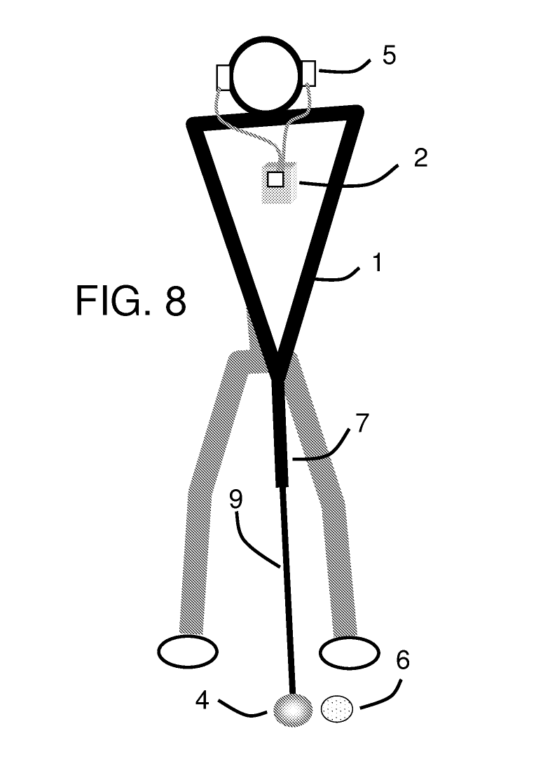

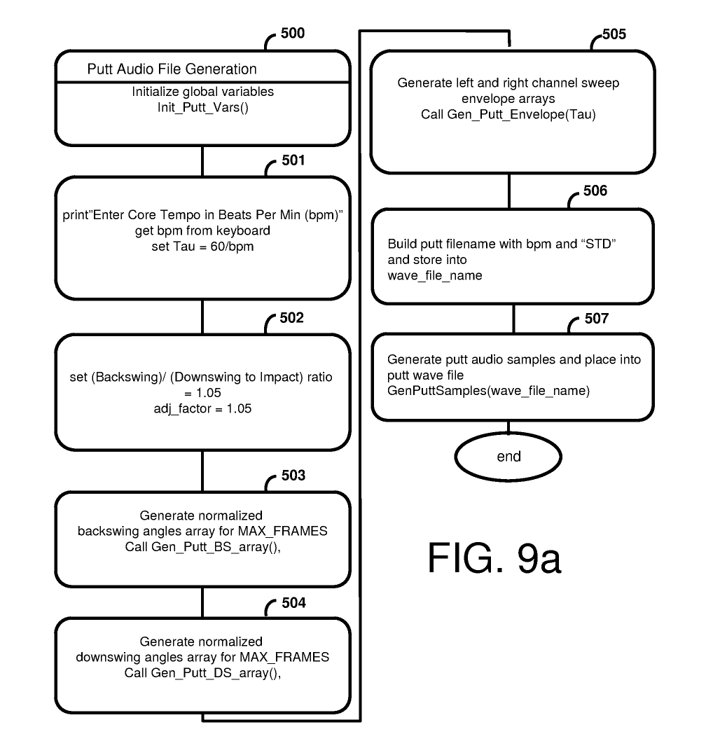

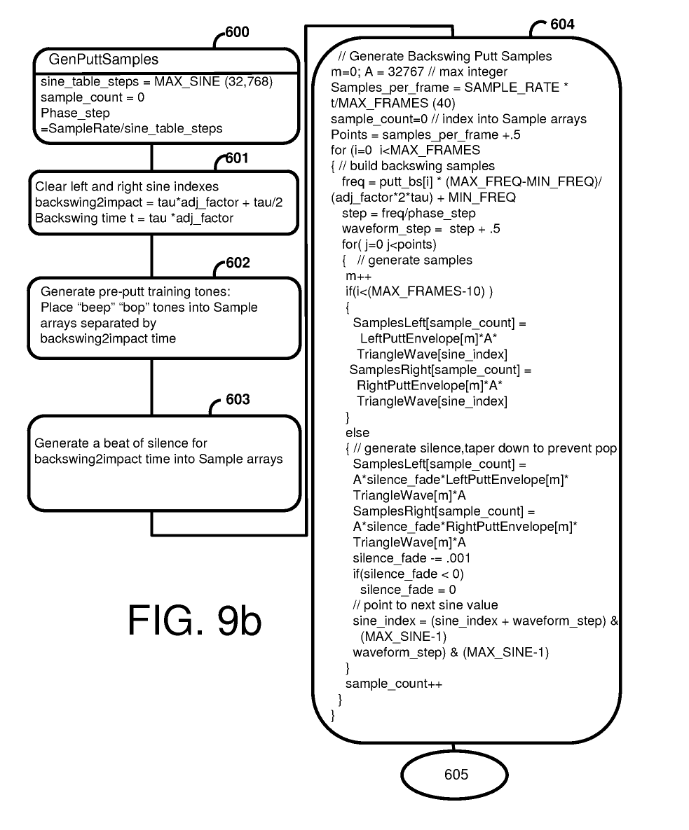

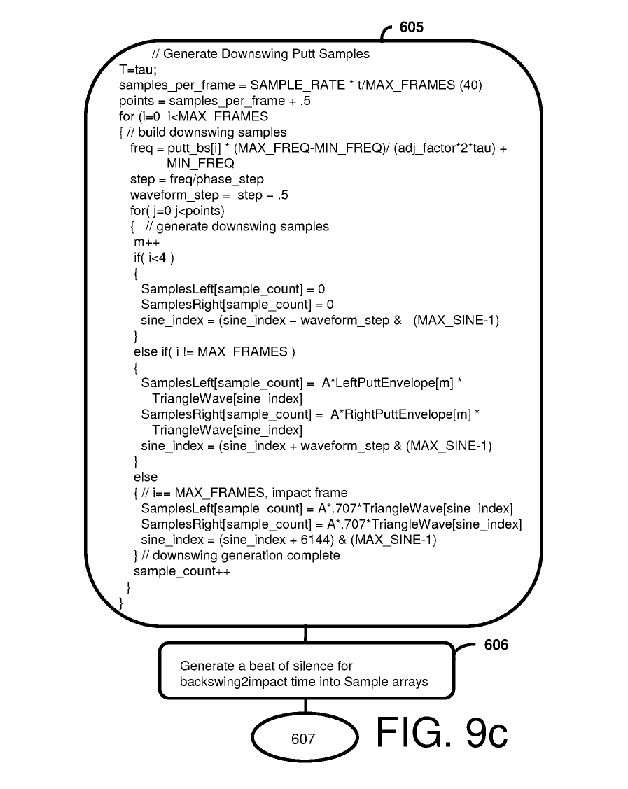

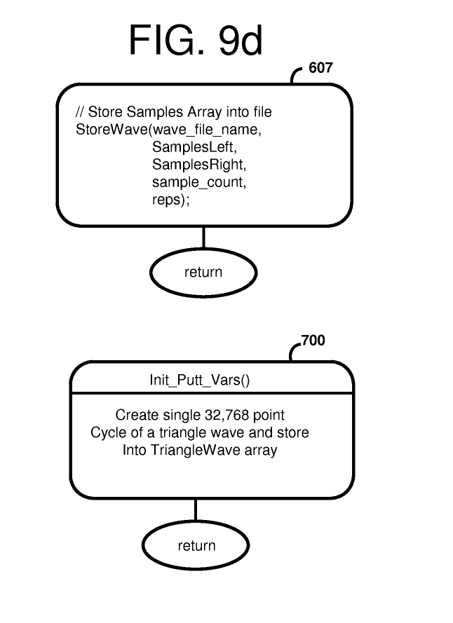

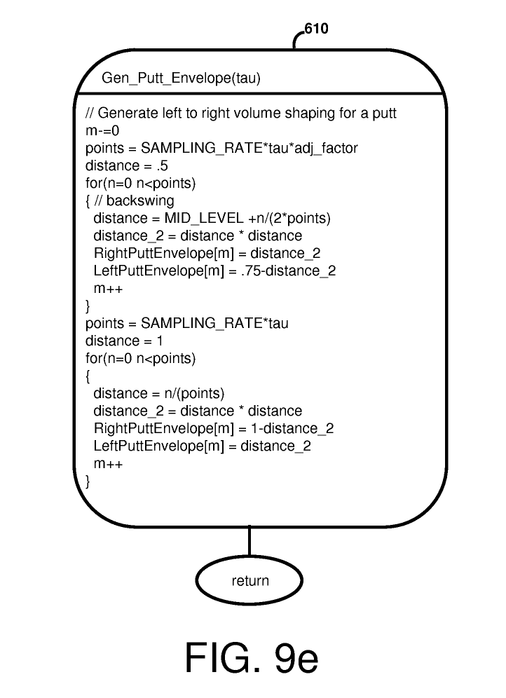

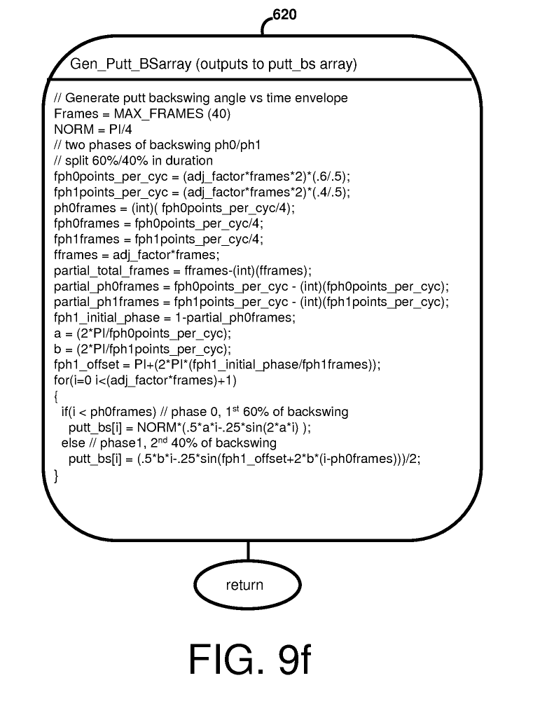

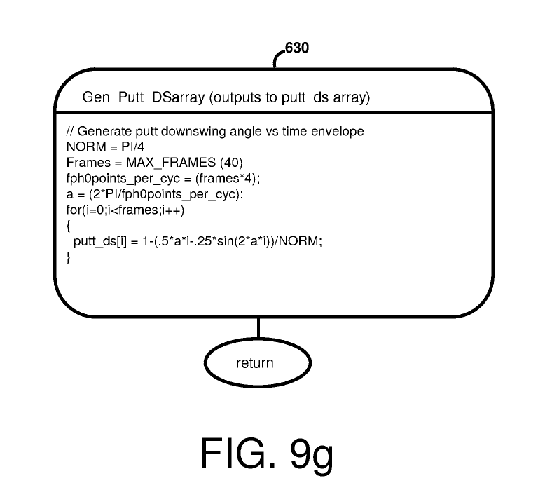

With reference to FIG. 1, golfer 1 is in the address position holding golf club 3. At the distal end of golf club 3 is clubhead 4 situated behind golf ball 6. Prior to the training sequence, golfer 1 selects Core Tempo full swing audio file on golfer's personal MP3 player 2 and listens through earbuds 5. Golfer 1 hears the pre-shot “beep” followed by a pause whose timing is equal to the takeaway to impact time. Takeaway to impact time is based on the golfer's Core Tempo in beats per minute as related to a Core Tempo half period time of 30/Core Tempo in seconds. Takeaway to the top and top to impact are the constituent parts of takeaway to impact. Top to impact is the core tempo half period timing. Takeaway to the top is the product of the Core Tempo half period and the Swing Ratio. Therefore, takeaway to impact is the sum of Core Tempo half period and the product of Core Tempo half period by the Swing Ratio. Golfer 1 then hears the pre-shot “bop” tone. In this embodiment, the “beep” tone is 1210 Hz while the “bop” tone is 605 Hz, but any pair of audible tones whose frequencies are an octave apart could be used. Golfer 1 now has the takeaway to impact timing beat in his mind. After a silence delay equal to the takeaway to impact time, golfer 1 starts the takeaway of golf club 3 from address position in FIG. 1 upon hearing the start of the backswing tone and takes golf club 3 back with the rising pitch of the tone. The pitch of the tone rises to a peak indicative of the speed of clubhead 4 then falls in pitch to silence just prior to reaching the top of the backswing in FIG. 2. Upon hearing the tone pitch rise again, golfer 1 executes a downswing reaching peak speed of clubhead 4 at impact position with golf ball 6 of FIG. 3, and continues the followthrough to finish position in FIG. 4 as the pitch of the tone falls to silence. Referencing FIG. 1, golfer 1 first selects an appropriate Core Tempo full swing audio file to listen to based on the personal tempo rate of golfer 1 and a Swing Ratio based on the backswing to downswing to impact ratio that best matches the swing dynamics of golfer 1. The Core Tempo of a golfer is best determined through frame by frame analysis of video of a golfer hitting golf balls such that the total frames from the initial start of the downswing to impact with the golf ball is noted. Twice the resultant downswing to impact time in frames multiplied by the frame time for the camera in seconds represents the downswing cycle time. Sixty divided by the downswing cycle time is the Core Tempo in beats per minute. The Core Tempo rate in beats per minute and the Swing Ratio are indicated within the name of the audio file. For example: a Core Tempo of 90 beats per minute and a Swing Ratio of 2.5 would be found in the Core Tempo file: “CoreTempo 90bpm 2_{—}5.mp3”. The file formats used in this embodiment are MP3 and Wave files. Wave files, once generated, are easily converted to MP3 files and vice versa. These file formats are common to most personal MP3 players and the IPOD® (Reg. Trademark Apple Computer Inc). MP3 Players are ubiquitous devices owned by almost everyone. Referring to FIG. 1, golfer 1 activates the selected Core Tempo file on MP3 player 2 and listens through earbuds 5. A pre-shot tone sequence consisting of an initial momentary “beep” tone followed by a second momentary “bop” tone sounding plays first. The time spacing between the two pre-shot tones is equal to the sum of the Core Tempo timing and the product of the Core Tempo timing multiplied by the Swing Ratio and represents the backswing to impact time. This time represents the time from initial takeaway FIG. 1 to the top of the backswing FIG. 2 to the impact of clubhead 4 with golf ball 6 of FIG. 3. Refer to FIG. 3. A silence beat follows the pre-shot tone sequence whose duration is also the backswing to impact time. At the conclusion of the silence beat, the backswing model sequence begins. Instead of using a single brief tone or cue to indicate the start of the backswing sequence and another tone to cue golfer 1 when to start the downswing, the Core Tempo Training Tone provides a continuous backswing audio signal whose frequency models the clubhead 4 backswing speed versus time. A higher pitch indicates faster speed while a lower pitch indicates slower speed. Upon completion of the backswing model sequence, the downswing sequence begins. The downswing sequence is a continuous audio signal that models clubhead 4 speed versus time starting at the top of the backswing and ending at impact. The backswing, downswing, and followthrough models were developed by DXP Tech LLC based on study of PGA Tour Golfers using 60 and 300 frame per second video. At the point in time where the peak speed of clubhead 4 occurs, a short impact chirp tone plays. The followthrough sequence begins after the completion of the impact chip tone. The followthrough sequence is a continuous signal whose frequency models clubhead 4 speed after collision with golf ball 6. The completion of the followthrough is shown in FIG. 4. The duration of the followthrough sequence is set equal to the backswing sequence duration. By loading the appropriate Core Tempo file onto MP3 player 2 of FIG. 4, golfer 1 of FIG. 4 can listen and be guided to a perfect tempo-consistent golf swing that matches his personal tempo and Swing Ratio. The initial pre-shot training sequence provides golfer 1 of FIG. 1 with a feel for the tempo of the swing before the swing begins. Just as a musician listens to a beat and can continue the beat after the music stops or can watch a conductor's gestured tempo and begin playing the first note of a piece on beat, golfer 1, can begin the backswing in synchronization with the backswing audio sequence after having heard the pre-shot sequence. Therefore, a human response delay need not be factored into the sequence since the pre-shot sequence alerts golfer 1 as to the swing's tempo beforehand. When the backswing sequence begins, golfer 1, takes the golf club 3 back while listening to the rising pitch which indicates faster speed. Toward the completion of the backswing, a lowering pitch indicates slower speed. Immediately after the backswing, the downswing sequence begins with a rising tone frequency that reaches a peak pitch at impact where clubhead 4 reaches its maximum speed. Golfer 1 of FIG. 3 has the training goal of striking golf ball 6 of FIG. 3 coincident with hearing the impact chirp tone signal and finishing the swing upon completion of the followthrough sequence.

With reference to FIG. 6, golfer 1 is in the address position prior to making a putting stroke holding putter 7. Shaft 9 of putter 7 is at address position. Prior to playing the putting training audio file, golfer 1 selects Puttronome putting stroke audio file on golfer's personal MP3 player 2 and listens through earbuds 5. Golfer 1 hears the pre-shot “beep” followed by a pause whose timing is equal to the takeaway to impact time. Golfer 1 then hears the pre-shot “bop” tone. Golfer 1 now has the takeaway to impact timing beat in his mind while addressing golf ball 6 with clubhead 4. After a silence pause equal to the takeaway to impact time, golfer 1 starts the takeaway of putter 7 from address position in FIG. 6 upon hearing the start of the backswing tone and takes putter 7 back with the rising pitch of the tone. Referring now to FIG. 7, the pitch of the tone rises to a peak indicative of the angle 8 of the shaft 9 of putter 7 from the initial shaft address position 10. The tone then goes silent just prior to reaching the top of the backswing position shown in FIG. 7. At the top of the backswing, upon hearing the tone pitch fall from the peak pitch of the backswing, golfer 1 executes a downswing reaching peak speed of clubhead 4 at impact position with golf ball 6 of FIG. 8. The Core Tempo rate in beats per minute is indicated within the name of the audio file. For the putting stroke, filenames are named “Puttronome” files. Full swing audio files are named “CoreTempo”. For example: a putting stroke audio file with a Core Tempo of 90 beats per minute would be found in the file: “Puttronome 90bpm.mp3” whereas, a golf swing audio file with a Core Tempo of 90 beats per minute and a Swing Ratio of 2.5 would be named “CoreTempo 90bpm 2_{—}5.mp3”.

FIGS. 5a through 5i depict the computer program product steps necessary to generate the Core Tempo Swing Training Tones through computer program software executing on a computer. The computer in this embodiment is a personal computer but could also be a server. Although the computer program steps detail how to build an audio file for later playback on numerous devices, they could easily be adapted to generate the audio tone signals in real-time from a PC, Netbook, PDA, embedded processor environment, or an iPhone® registered trademark of Apple Computer Inc. Within each step, Program Design Language or PDL details the sequential process. Those skilled in the art understand PDL as an effective means of documenting software design. A computer source listing written in ‘C’ and compatible with Microsoft® compilers provides additional detail and can be found in Appendix I.

Referring to FIG. 5a, step 70 is the main entry point of the computer program. Variables are initialized by a call to Init_Vars( )in step 70. The function Init_Vars is shown in step 300 of FIG. 5g. The Sine_Wave[MAX_SINE] array is initialized with a 32,768 point single cycle of a sine wave that ranges from −1 to +1 and is used to generate phase continuous audio signals. SampleRate is set to 16000 samples per second. In this embodiment, SampleRate is set to 16000 but could be set to any other rate not limited to 16000. Returning from function FIG. 5g step 300 Init_Vars, ‘S’ is entered for full swing, or ‘P’ for a putt is entered in FIG. 5a step 80. If the character entered into the computer's keyboard is ‘S’, the computer program branches to step 100, otherwise, the program branches to step 500 if ‘P’ is selected. Referring to FIG. 5a, step 100 is the start of the full swing generation process. Init_Swing_Vars is call in step 100 which sets ClubLength in step 350 of FIG. 5g. ClubLength in this embodiment is set to the typical driver length of 3.833 feet but could be set to any length associated with other clubs. The user is asked to enter the Core Tempo in beats per minute (bpm) in step 101. The time period of bpm in seconds is bpmTau which equals 60/bpm. DSSamples2Impact, the downswing to impact number of samples, equals SampleRate*bpmTau/2. In step 102 the SwingRatio is entered which is the ratio of the backswing to the downswing to impact time. BSSamples, the number of backswing samples, equals SwingRatio*DSSamples2Impact. In step 103, the peak backswing angular velocity (wpk) is computed. In step 104, club backswing velocity is computed for each sample from the club backswing angular velocity modeled by: [0.5−0.5*cos(4*Pri/BSSamples)] where PI is 3.14159. Step 105 calls the function get_peak_rads which returns the peak radians per second clubhead speed at impact based on the Core Tempo. The function get_peak_rads is based on a model developed by DXP Tech LLC and relates the golfer's Core Tempo in beats per minute to the peak clubhead 4 of FIG. 3 speed in radians per second. Step 106 computes the downswing angular velocity based on the equation f(x)=(4/k)*ê(4x/k) where k is the number of samples in the downswing to impact phase. The peak model angular velocity, wpk, is the equation evaluated for k=DSSamples2Impact−1. The equation models the downswing angular velocity of clubhead 4 of FIG. 3 based on analysis of PGA Tour Professionals by DXP Tech LLC. Club_DS_Velocity is evaluated for each sample of the downswing and equals: CLUBLENGTH*peak_rads*(4/DS2ImpactSamples)*(exp̂(4i/(DS2ImpactSamples−1))/wpk. Processing continues in step 107 of FIG. 5b in which FTSamples, the number of followthrough samples, is set equal to BSSamples, the number of backswing samples. The peak speed of clubhead 4 of FIG. 3 for the followthrough phase, peak_speed, is set to the peak speed of clubhead 4 of FIG. 3 at impact multiplied by a reduction factor, V1_AFTER in step 107 of FIG. 5b, which accounts for the slowing of the 210 gram clubhead 4 of FIG. 3 after collision with 45 gram golf ball 6 of FIG. 3. The followthrough phase is modeled by using a mirror image of the downswing model using the total timing of the backswing phase. The peak model angular velocity term, wpk, is calculated in step 107 of FIG. 5b. In step 108 of FIG. 5b, clubhead followthrough velocity, Club_FT_Velocity[FTSamples−i] is computed for each sample. Step 109 of FIG. 5c calls GenSwingEnvelope step 310 of FIG. 5h which builds a left and right channel envelope that controls the volume level of the final SamplesLeft and SamplesRight arrays in order to provide a left to right sweep during the backswing and a right to left sweep during the downswing that enhances the training experience of golfer 1 of FIG. 1. In step 110 of FIG. 5c, the filename for a specific Core Tempo in beats per minute and Swing Ratio is constructed and stored in wave_file_name string. Step 111 of FIG. 5c calls the function GenSwingWave, which generates audio samples using the backswing, downswing, and followthrough velocity arrays. Referring now to FIG. 5d, GenSwingWave begins in step 200. The variable sample_count is initialized to 0. The variable phase_step is set equal to the sample_rate divided by the total sine table steps. BSSamples2Impact, or the number of samples from the start of the backswing to impact, is set to the sum of BSSamples and DSSamples in step 201. The left and right sine indexes are initialized to 0 in step 201. The pre-shot training tones are generated separated by BSSamples2Impact time in step 202 of FIG. 5d. Step 203 of FIG. 5d places a beat of silence after the pre-shot training tones in anticipation of the start of the backswing generation. Step 204 of FIG. 5d generates the backswing sequence by multiplying each Club_BS_Velocity array member by SPEED_FACTOR to convert the modeled clubhead backswing velocity to a frequency. In this embodiment, SPEED_FACTOR is set to 15.7 but is not limited to 15.7. Each subsequent waveform step used as an index into the SineWave array is updated based on freq/phase_step. Each frame of samples consists of sample_rate*frame_time=points. For each point, SamplesLeft[sample_count] and SamplesRight[sample_count] arrays are filled with the next value taken from the SineWave array multiplied by Left and Right Envelope arrays respectively. After each sample stored in the Sample arrays, sample_count is incremented. After completing the backswing sample generation, the downswing generation continues in step 205 of FIG. 5e. Step 205 of FIG. 5e generates the downswing to impact samples by multiplying each Club_DS_Velocity array member by SPEED_FACTOR. Each subsequent waveform step used as an index into the SineWave array is updated based on freq/phase_step. For each point, SamplesLeft[sample_count] and SamplesRight[sample_count] arrays are filled with the next value taken from the SineWave array multiplied by Left and Right Envelope arrays respectively. After each sample is stored in the left channel and right channel sample arrays, sample_count, the index into the sample arrays, is incremented. The process of GenWave continues in step 206 of FIG. 5f where the followthrough samples are generated. Step 206 of FIG. 5f generates the followthrough to finish samples by multiplying each Club_FT_Velocity array member by SPEED_FACTOR. Each subsequent waveform step into the SineWave array is updated based on freq/phase_step. For the first frame, i=0, the maximum speed of clubhead 4 of FIG. 3 occurs. During frame i=0 of step 206 of FIG. 5f, an impact chirp signal is generated at a frequency of 4000 Hz. A short burst of 4000 Hz sinewaves produces a sound similar to the impact of clubhead 4 of FIG. 3 with golf ball 6 of FIG. 3. After the burst is generated, the followthrough signal is generated and stored into the SampleLeft and SampleRight arrays in step 206 of FIG. 5f. Step 207 of FIG. 5g places a post followthrough silence period whose duration is equal to the backswing to impact time into the SamplesLeft and SamplesRight arrays. The sample arrays are now complete and require final storage to the computer file as shown in step 208 of FIG. 5g where the function, StoreWave( )is called with wave_file_name, SamplesLeft, SamplesRight, sample_count, and the number of repetitions=1 being passed in the function call. The StoreWave function shown in step 400 of FIG. 5i formats the SampleLeft and SampleRight waveform into the WAVE file specification. Those skilled in the art understand computer audio file formats such as the WAVE file format. The file is opened and descriptors are written in step 400 of FIG. 5i. In FIG. 5i step 401, the main body of the WAVE file is stored using the data generated into the SamplesLeft and SamplesRight arrays. At the completion of the WAVE file writes, the file is closed and control is returned to the next line from where StoreWave was called in step 208 of FIG. 5g. After step 208 of FIG. 5g completes, control is returned to where GenSwingWave was called in step 111 of FIG. 5c. After completion of step 111 of FIG. 5c, the program terminates. The resulting generated WAVE file can be played on a PC directly or can be converted to other file formats such as MP3 or WMA through readily available conversion programs for playing on a variety of MP3 Players.

Referring to FIG. 5a, step 90, if a ‘P’ is entered, putting stroke file generation begins at step 500 of FIG. 9a where Init_Putt_Vars is called. Init_Putt_Vars is shown in step 700 of FIG. 9d and initializes TriangleWave array with a single cycle of a triangle wave. A triangle wave was selected as the basis function for the putting stroke audio generation. The triangle wave is comprised of 32,768 points. Referring to FIG. 9a, the Core Tempo of the putting stroke in beats per minute is entered in step 501. Tau, or the time period for the downswing, is set to 60/bpm in step 501. The adjustment factor, adj_factor is set to 1.05 in step 502. This factor represents the backswing to downswing ratio in the putting stroke. The average value is approximately 1.05 for the majority of professional golfers and departs from the 1.0 factor typically associated with a pendulum stroke. Step 503 calls Gen_Putt_BS_array step 620 of FIG. 9f, which generates normalized backswing angles for each of MAX_FRAMES frames into the putt_bs_array as shown in step 620 of FIG. 9f. In this embodiment, MAX_FRAMES is 40. Step 504 of FIG. 9a calls Gen_Putt_DS_array which generates normalized downswing angles for each of MAX_FRAMES frames into the putt_ds_array as shown in step 630 of FIG. 9g. Gen_Putt_DS_array as well as Gen_Putt_BS_array generates downswing angles according to the formula y=0.5x−0.25sin(2x) which models the backswing angle of an accelerating putting stroke. Both arrays putt_bs_array and putt_ds_array are used later by GenPuttSamples which starts at step 600 of FIG. 9b. Continuing with FIG. 9a, step 505 calls Gen_Putt_Envelope that starts at step 610 of FIG. 9e and generates volume level control that shapes the left to right and right to left sweep that enhances the golfer's training experience. Step 610 of FIG. 9e writes volume level values into LeftPuttEnvelope and RightPuttEnvelope arrays which will be used later by GenPuttSamples starting at step 600 of FIG. 9b. Referring to FIG. 9a, step 506 builds the filename under which the audio file will be stored. The wave_file_name string is constructed with the tempo in beats per minute and the string “STD” embedded. Step 507 of FIG. 9a calls GenPuttSamples which starts at step 600 of FIG. 9b.

Referring now to FIG. 9b, GenPuttWave begins in step 600. The variable sample_count is initialized to 0. The variable phase_step is set equal to the sample_rate divided by the total sine table steps. BSSamples2Impact, or the number of samples from the start of the backswing to impact, is set to the sum of Tau*adj_factor+Tau/2 in step 601. The left and right sine indexes are initialized to 0 in step 601. The pre-putt training tones are generated separated by BSSamples2Impact time in step 602 of FIG. 9b. Step 603 of FIG. 9b places a beat of silence after the pre-putt training tones in anticipation of the start of the backswing generation. Step 604 of FIG. 9b generates the backswing putt sequence for MAX_FRAMES each frame having a waveform generated at a frequency based on putt_bs[i]*(MAX_FREQ−MIN_FREQ)/(adj_factor*2*tau)+MIN_FREQ. In this embodiment, MAX_FREQ is 500 Hz and MIN_FREQ is 150 Hz. Each frame's frequency is used to determine a step size which is used as a modulo index (32,768) into the TriangleWave array based on freq/phase_step. Each frame of samples consists of sample_rate*frame_time=points. For each point, SamplesLeft[sample_count] and SamplesRight[sample_count] arrays are filled with the next value taken from the TriangleWave array multiplied by Left and RightPuttEnvelope arrays respectively. After each sample stored in the Sample arrays, sample_count is incremented. After completing the putt backswing sample generation, the downswing generation continues in step 605 of FIG. 9c. Step 605 of FIG. 9c generates the putt downswing to impact samples sequence for MAX_FRAMES each frame having a waveform generated at a frequency based on putt_ds[i]*(MAX_FREQ−MIN_FREQ)/(adj_factor*2tau)+MIN_FREQ. Each subsequent waveform step used as an index into the TriangleWave array is updated based on freq/phase_step. For each point, SamplesLeft[sample_count] and SamplesRight[sample_count] arrays are filled with the next value taken from the TriangleWave array multiplied by Left and RightPuttEnvelope arrays respectively. At i=MAX_{—} FRAMES, the maximum speed occurs and a chirp sound is generated indicating impact. During the generation of the chirp sound, the TriangleWave sine_index value is fixed at 6144 which generates a high pitched sound indicative of impact. After each sample is stored in the left channel and right channel sample arrays, sample_count, the index into the sample arrays, is incremented. The process of GenPuttWave continues in step 606 of FIG. 9c where a beat of silence for backswing to impact time samples of 0 value is generated. The sample arrays are now complete and require final storage to the computer audio file as shown in step 607 of FIG. 9d where the function, StoreWave( ) is called with wave_file_name, SamplesLeft, SamplesRight, sample_count, and the number of repetitions=1 being passed in the function call. At the completion of the WAVE file writes, the file is closed and control is returned to the next line from where StoreWave was called in step 607 of FIG. 9d. After step 607 of FIG. 9d completes, control is returned to where GenPuttSamples was called in step 507 of FIG. 9a. After completion of step 507 of FIG. 9a, the program terminates. The resulting generated WAVE file can be played on a PC directly or can be converted to other file formats such as MP3 or WMA through readily available conversion programs for playing on a variety of MP3 Players.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the claims. For instance, the computer program software process used to generate the Core Tempo Training Tones could easily be ported to an embedded microprocessor with a Digital to Analog converter or a pulse code modulator output stage to generate audio for headphone or speaker use. In such an embodiment, the training tones could be played to headphones or speakers without the need for an MP3 Player. In addition, the computer program product software could be ported to serve as an IPHONE® App. (Reg. Trademark Apple Computer Inc)

What is claimed is:

1. A method of generating a computer-readable golf swing audio file that models a preferred tempo-consistent golf swing used for training a golfer in how to make said preferred tempo-consistent golf swing with a golf club and strike a golf ball comprising the steps of:
(a) inputting a core tempo beats per minute relating to a core tempo half period that matches a personal downswing to impact timing of said golfer;
(b) inputting a backswing to downswing to impact swing ratio from 2.0 to 4.0;
(c) opening said computer-readable golf swing audio file with a filename incorporating said core tempo beats per minute and said backswing to downswing to impact swing ratio to store generated digital audio samples;
(d) generating a pre-shot training sequence comprising a first beep and second bop momentary digital tone signal whose time spacing equals a sum of said core tempo half period and a product of said core tempo half period multiplied by said backswing to downswing to impact swing ratio;
(e) generating a digital silence pre-shot pause period whose duration equals said sum of said core tempo half period and said product of said core tempo timing multiplied by said backswing to downswing to impact swing ratio;
(f) generating a continuous backswing digital audio signal whose frequency is proportional to a backswing velocity model of a clubhead of said golf club for a duration equal to said product of said core tempo half period multiplied by said backswing to downswing to impact swing ratio;
(g) generating a continuous downswing digital audio signal whose frequency is proportional to a downswing velocity model of said clubhead of said golf club for a duration equal to said core tempo half period;
(h) generating a short impact chirp digital tone signal which indicates a peak speed of said clubhead of said golf club;
(i) generating a continuous post-impact followthrough digital audio signal whose frequency is proportional to a followthrough velocity model of said clubhead of said golf club after collision with said golf ball for a duration equal to said product of said core tempo half period multiplied by said backswing to downswing to impact swing ratio;
(j) generating a post-followthrough digital silence period for a duration equal to said sum of said core tempo half period and said product of said core tempo half period multiplied by said backswing to downswing to impact swing ratio;
(k) closing said computer-readable golf swing audio file associated with said filename.

2. The method of claim 1 wherein golf club is a putter and the frequency of digital audio signals generated is proportional to an angular displacement model of said putter.

3. A processor-readable medium useful in association with a computer which includes a processor and a memory, the computer readable medium including computer instructions which are configured to cause said computer to create a computer-readable golf swing audio file from parameters entered by a user useful in training a golfer in how to make a preferred tempo-consistent golf swing by:
(a) inputting a core tempo beats per minute from said user relating to a core tempo half period that matches a personal downswing to impact timing of said golfer;
(b) inputting a backswing to downswing to impact swing ratio from said user ranging from 2.0 to 4.0;
(c) opening said computer-readable golf swing audio file with a filename incorporating said core tempo beats per minute and said backswing to downswing to impact swing ratio to hold generated digital audio samples;
(d) generating a pre-shot training sequence comprising a first beep and second bop momentary digital tone signal whose time spacing equals a sum of said core tempo half period and a product of said core tempo half period multiplied by said backswing to downswing to impact swing ratio;
(e) generating a digital silence pre-shot pause period whose duration equals said sum of said core tempo half period and said product of said core tempo timing multiplied by said backswing to downswing to impact swing ratio;
(f) generating a continuous backswing digital audio signal whose frequency is proportional to a backswing velocity model of a clubhead of said golf club for a duration equal to said product of said core tempo half period multiplied by said backswing to downswing to impact swing ratio;
(g) generating a continuous downswing digital audio signal whose frequency is proportional to a downswing velocity model of said clubhead of said golf club for a duration equal to said core tempo half period;
(h) generating a short digital chirp signal which indicates a peak speed of said clubhead of said golf club;
(i) generating a continuous post-impact followthrough digital audio signal whose frequency is proportional to a followthrough velocity model of said clubhead of said golf club after collision with said golf ball for a duration equal to said product of said core tempo half period multiplied by said backswing to downswing to impact swing ratio;
(j) generating a post-followthrough digital silent period for a duration equal to said sum of said core tempo half period and said product of said core tempo half period multiplied by said backswing to downswing to impact swing ratio;
(k) closing said computer-readable golf swing audio file associated with said filename.

4. The processor-readable medium of claim 3 wherein computer-readable audio file is based on a putting stroke and the frequency of digital audio signals generated is proportional to an angular displacement model of a putter.

5. A method for training a golfer in how to execute a golf swing with a golf club said method comprising the steps of:
(a) selecting a computer-readable golf swing audio file on a media player based on a core tempo beats per minute relating to a core tempo half period that matches a personal downswing to impact timing of said golfer and a swing ratio;
(b) producing a pre-shot training sequence comprising a first beep and second bop momentary tone whose time spacing equals a sum of said core tempo half period and a product of said core tempo half period multiplied by said backswing to downswing to impact swing ratio;
(c) producing a silence pre-shot pause period whose duration equals said sum of said core tempo half period and said product of said core tempo timing multiplied by said backswing to downswing to impact swing ratio;
(d) producing a continuous backswing audio signal whose frequency is proportional to a backswing velocity model of a clubhead of said golf club for a duration equal to said product of said core tempo half period multiplied by said backswing to downswing to impact swing ratio;
(e) producing a continuous downswing audio signal whose frequency is proportional to a downswing velocity model of said clubhead of said golf club for a duration equal to said core tempo half period;
(f) producing a short impact chirp tone signal which indicates a peak speed of said clubhead of said golf club;
(g) producing a continuous post-impact followthrough audio signal whose frequency is proportional to a followthrough velocity model of said clubhead of said golf club after collision with said golf ball for a duration equal to said product of said core tempo half period multiplied by said backswing to downswing to impact swing ratio;
(h) producing a post-followthrough silence period for a duration equal to said sum of said core tempo half period and said product of said core tempo half period multiplied by said backswing to downswing to impact swing ratio;
wherein said golfer synchronizes movements of said golf club to audio signals produced by said media player.

6. The method of claim 5 wherein golf club is a putter and the frequency of audio signals produced is proportional to an angular displacement model of said putter.
